(19) United States
(12) Patent Application Publication
(10) Pub. No.: US 2024/0078241 A1
(43) Pub. Date: Mar. 7, 2024

(54) MANAGING DATA INGESTION AND STORAGE

(71) Applicant: INTERNATIONAL BUSINESS MACHINES CORPORATION, ARMONK, NY (US)

(72) Inventors: Neerju Gupta, Chelmsford, MA (US); Namit Kabra, Hyderabad (IN); Yannick Saillet, Stuttgart (DE)

(21) Appl. No.: 17/930,224

(22) Filed: Sep. 7, 2022

(51) Int. Cl. G06F 16/2457; G06F 16/23

(52) U.S. Cl. CPC G06F 16/24578; G06F 16/2365

(57) ABSTRACT

An embodiment for managing data using machine learning models and information governance. The embodiment may automatically detect a data analysis request made within a system and identify subject datasets. The embodiment may automatically conduct shallow term assignments on each row and column of data in the subject datasets and automatically match the shallow term assignments for each row and column with a stored set of ranked terms, and automatically flag rows or columns matching with ranked terms above a predetermined threshold ranking for further analysis. The embodiment may automatically and continuously monitor and detect irrelevant metadata types to prevent subsequent analysis and storage of data including the irrelevant metadata types. The embodiment may automatically generate a criticality ranking for stored analysis datasets. The embodiment may detect low priority analysis datasets having a criticality ranking below a criticality threshold, and automatically place the low priority analysis datasets into cold storage.

### BACKGROUND

The present application relates generally to data management, and more particularly, to managing data using machine learning models and information governance to both limit data ingestion as well as limit inefficient data storage within data analysis environments.

Data analysis tools are commonly used by various businesses to identify, sort, retrieve, or otherwise characterize large amounts of data. This data may reside within tables, databases, or even large data lakes. Using data analysis tools to scan large volumes of data generally results in the generation of large amounts of additional data and metadata. Thus, data management often concerns both data ingestions and data storage within various data analysis environments.

### SUMMARY

According to one embodiment, a method, computer system, and computer program product for managing data is provided. The embodiment may include automatically detecting a data analysis request made within a system and identifying one or more subject datasets. The embodiment may also include automatically conducting shallow term assignments on each row and column of data in the subject datasets, the shallow term assignments comprising a domain classification. The embodiment may also include automatically matching the shallow term assignments for each row and column with a stored set of ranked terms. The embodiment may further include automatically flagging rows or columns matching with ranked terms in the stored set of ranked terms above a predetermined threshold ranking for performing further analysis. The embodiment may also include automatically and continuously monitoring and detecting irrelevant metadata types within the flagged rows or columns by continuously utilizing historical usage data to prevent subsequent analysis and storage of data including the irrelevant metadata types. The embodiment may further include, in response to detecting a stored analysis dataset, automatically generating a criticality ranking for the stored analysis dataset, the criticality ranking comprising a numerical probability of usability for the analysis dataset. The embodiment may also include, in response to detecting low priority analysis datasets having a criticality ranking below a criticality threshold, automatically placing the low priority analysis datasets into cold storage.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment; and

FIG. 2 illustrates an operational flowchart for a process of managing data using machine learning models and information governance according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to data management, and more particularly, to managing data using machine learning models and information governance to both limit data ingestion as well as limit inefficient data storage within data analysis environments. The following described exemplary embodiments provide a system, method, and program product to, among other things, automatically detect a data analysis request made within a system and identify one or more subject datasets, automatically conduct shallow term assignments on each row and column of data in the subject datasets, the shallow term assignments including a domain classification, automatically match the shallow term assignments for each row and column with a stored set of ranked terms, and automatically flag rows or columns matching with ranked terms in the stored set of ranked terms above a predetermined threshold ranking for performing further analysis. The provided exemplary embodiments may then automatically and continuously monitor and detect irrelevant metadata types within the flagged rows or columns by continuously utilizing historical usage data to prevent subsequent analysis and storage of data including the irrelevant metadata types, and, in response to detecting a stored analysis dataset, automatically generate a criticality ranking for the stored analysis dataset, the criticality ranking including a numerical probability of usability for the analysis dataset, and lastly, in response to detecting low priority analysis datasets having a criticality ranking below a criticality threshold, automatically place the low priority analysis datasets into cold storage. Therefore, the present embodiment has the capacity to improve data management by using machine learning models and information governance to both limit data ingestion as well as limit inefficient data storage within data analysis environments.

As previously described, data analysis tools are commonly used by various businesses to identify, sort, retrieve, or otherwise characterize large amounts of data. This data may reside within tables, databases, or even large data lakes. Using data analysis tools to scan large volumes of data generally results in the generation of large amounts of additional data and metadata. This creates challenges related to managing storage space as increasing amounts of data are analyzed and more analysis data is generated. The challenge of managing storage space is often times amplified by the inability of many analysis tools to differentiate between high priority data and low priority data. For example, a data analysis tool may perform the same amount of analysis and generate the same amount of data for a highly priority column of data as it does for an irrelevant or low priority column of data. At high volumes and scale, this deficiency in data analysis tools can create or amplify these storage space challenges. Storage space challenges often demand tedious micromanagement that is both time consuming and costly for businesses, as many data analysis environments require manual intervention to manage storage space. Accordingly, a method for managing data using machine learning models and information governance to both limit data ingestion (thereby limiting data generation) as well as limit inefficient data storage within data analysis environments would be advantageous for a variety of businesses.

According to at least one embodiment of a computer system capable of employing methods in accordance with the present invention to manage data, the method, system, computer program product may automatically detect a data analysis request made within a system and identify one or more subject datasets. The method, system, computer program product may automatically conduct shallow term assignments on each row and column of data in the subject datasets, the shallow term assignments including a domain classification. Next, the method, system, computer program product may automatically match the shallow term assignments for each row and column with a stored set of ranked terms. The method, system, computer program product may then automatically flag rows or columns matching with ranked terms in the stored set of ranked terms above a predetermined threshold ranking for performing further analysis. Then, the method, system, computer program product may automatically and continuously monitor and detect irrelevant metadata types within the flagged rows or columns by continuously utilizing historical usage data to prevent subsequent analysis and storage of data including the irrelevant metadata types. The method, system, computer program product may then, in response to detecting a stored analysis dataset, automatically generate a criticality ranking for the stored analysis dataset, the criticality ranking including a numerical probability of usability for the analysis dataset. Lastly, the method, system, computer program product may, in response to detecting low priority analysis datasets having a criticality ranking below a criticality threshold, automatically place the low priority analysis datasets into cold storage. In turn, the method, system, computer program product has provided improved management of analysis data using machine learning models and information governance to both limit data ingestion (thereby limiting data generation) as well as inefficient data storage within data analysis environments. The method, system, computer program product can improve management of data at various points in a given data analysis workflow by limiting data ingestions and generation earlier in the workflow, and by limiting inefficient data storage later in the workflow.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

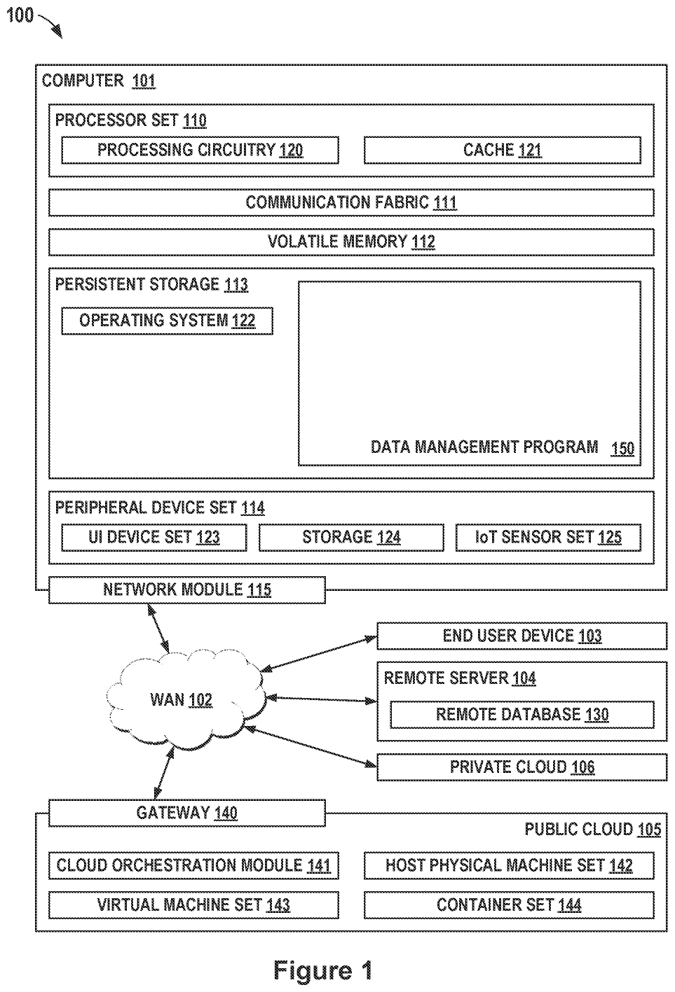

Referring now to FIG. 1, computing environment 100 contains an example of an environment for the execution of at least some of the computer code involved in performing the inventive methods, such as analysis data management program/code 150. In addition to analysis data management code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and analysis data management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in analysis data management code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in analysis data management code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

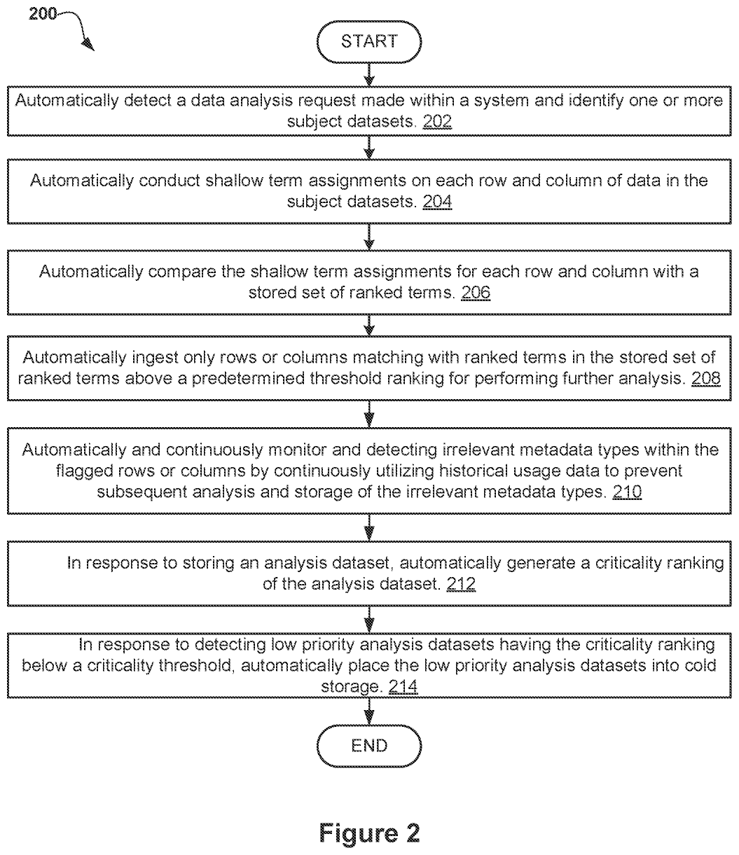

Referring now to FIG. 2A, an operational flowchart depicting a process 200 for managing data using machine learning models and information governance according to at least one embodiment is provided. At 202, analysis data management program 150 automatically detects data analysis requests made within a given system and identifies one or more subject datasets. Analysis data management program 150 may, for example, detect that a user has manually input a request. Alternatively, analysis data management program 150 may detect a request that is automated or routine in nature. The system may be any suitable environment capable of storing data in a form that may be analyzed by conventional data analysis tools. In the context of this disclosure, the subject dataset is any dataset that analysis data management program 150 has detected as being the subject of any data analysis request.

At 204, analysis data management program 150 automatically conducts shallow term assignments on each row and column of data in the subject datasets. For example, if analysis data management program 150 detects a subject dataset including an exemplary ‘Table A’, analysis data management program 150 will automatically conduct shallow term assignments on each row and column within ‘Table A’. A shallow term assignment is a preliminary characterization of each row or column that includes a classification of the data contained therein and its domain. The shallow term assignment may be determined using metadata and column or row names. In other embodiments, analysis data management program 150 may conduct shallow term assignments for each table in a dataset by analyzing only the first N number of rows to determine a classification or domain. For example, an exemplary row or column in a domain related to loan requests may be assigned a shallow term assignment that identifies the row or column as being related to ‘Monthly Wages’.

At 206, analysis data management program 150 automatically matches the shallow term assignments for each row and column with a stored set of ranked terms. In embodiments, the ranked terms may be domain-specific, and may be manually marked and configured by a user. In other embodiments, the ranked terms may be automatically determined by considering usage data, number of policies related to the term, number of rules related to the term, number of reports related to the term, the relationship of the term to other high ranking terms, or any other useful data in determining the importance of a given term. The terms may also be ranked using a combination of any or all of these factors. If no exact match is found between the shallow term assignment and the ranked terms, analysis data management program 150 may match the shallow term assignment of each row or column with the closest ranked term by using metadata and natural language analyses. The ranked terms may be represented with a calculated numeric ranking between 0 and 1.0 where 0 represents an irrelevant term, and numbers closer to 1.0 represent terms with higher importance and ranking. For example, in an exemplary domain related to loan approvals, analysis data management program 150 may have conducted a shallow term assignment for a first column in a dataset that is classified as ‘Monthly Wages’. In the domain relating to loan approvals, analysis data management program 150 will attempt to match the shallow term assignment to the known ranked terms. Even if there is no exact match, analysis data management program 150 may determine, for example, that one of the ranked terms in this domain is ‘Monthly Income’. While not an exact match, analysis data management program 150 may use any suitable known natural language processing tools as well as the calculated numeric ranking to identify that the term ‘monthly wages’ is closely related to ‘monthly income’ and thus match the shallow term assignment to the ranked term.

At 208, analysis data management program 150 will automatically flag rows or columns matching with ranked terms in the stored set of ranked terms above a predetermined threshold ranking for performing further analysis. For example, using the previous example, analysis data management program 150 matched the column including ‘Monthly Wages’ with the ranked term ‘Monthly Income’. If analysis data management program 150 is configured to flag data that is matched with rank terms having a numerical ranking of greater than 0.7 and ‘Monthly Income’ is a ranked term having a numerical rank of 0.9, then analysis data management program 150 will flag the ‘Monthly Wages’ column, or any column matched with the ranked term ‘Monthly Income’ as being a subject dataset for further analysis. If analysis data management program 150 determines that a row or column is matched with a ranked term having a numerical ranking below the threshold, then this data will be flagged as unsuitable for further analysis. This effectively limits the amount of data that will be further analyzed, thereby limiting the amount of additional data generated and subsequently stored.

At 210, analysis data management program 150 automatically and continuously monitors and detects irrelevant metadata types within the flagged rows or columns by continuously utilizing historical usage data to prevent subsequent analysis and storage of data including the irrelevant metadata types. Analysis data management program 150 may use a variety of factors in determining irrelevant metadata types. For example, analysis data management program 150 may consider which datasets were requested to be deleted manually, past usage of datasets, ratings of datasets, pattern profiling results, format and frequency distributions, and any other factors relating to the usability of a given dataset. In embodiments, analysis data management program 150 may calculate a probability of usability value for a given metadata type and ultimately classify any metadata type having a probability of usability below a threshold value as an irrelevant metadata type. Analysis data management program 150 may then prevent subsequent analysis of data including the irrelevant metadata types. The details of how analysis data management program 150 determines probability of usability will be further discussed below.

At 212, analysis data management program 150, in response to detecting a stored analysis dataset, automatically generates a criticality ranking of the stored analysis dataset. The criticality ranking may be a numerical ranking calculated using any number of useful factors for determining the importance or priority that should be attributed to any detected stored analysis dataset. A non-exhaustive and merely illustrative list of factors that analysis data management program 150 may consider in generating the criticality ranking for stored analysis datasets will be described below. Analysis data management program 150 may consider any number of these factors and may be configured to assign any desired weight to any factor. The criticality ranking represents a probability of usage for a given stored dataset. The criticality ranking may be represented as a number between 0 and 100 representing a percentage corresponding to a probability of usage, or in any other suitable numerical way.

Analysis data management program 150, in generating the criticality ranking of the stored analysis data may consider, for example, column profiling data including what data was accessed, not accessed, time it was last accessed, and frequency of access. Analysis data management program 150 may also consider profiling results for datasets that are matched with higher ranked terms. Analysis data management program 150 may also consider the formats of the data accessed, including an analysis of whether the format is an outlier. Analysis data management program 150 may further consider data types for each column and frequency of access for each column. Analysis data management program 150 may further consider column size, data of data importation, date of profiling, and dates of modification. Analysis data management program 150 may further consider any relevant governance policies or data rules attached to a stored dataset. For example, a column that breaks a policy or data rule may be more important in a situation where someone is working to rectify a related issue than a column that has no policy or rules attached to it. Analysis data management program 150 may further consider the user who is triggering the data profile including the user's role or privileges. Analysis data management program 150 may further consider number of workspaces and users involved, as this may indicate higher usage of a dataset, indicating it should be afforded higher priority. Analysis data management program 150 may further consider duration of historic analyses performed on similar datasets, as datasets that may be analyzed quickly can be recreated quite easily without the need for storage. Analysis data management program 150 may further consider historical manual interventions or purging of datasets, lowering the priority of datasets that are similar to datasets that were manually purged.

At 214, analysis data management program 150, in response to detecting low priority datasets having a criticality ranking below a criticality threshold, automatically places the low priority analysis datasets into cold storage. For example, cold storage may provide a safe location for data that is not in frequent use, like old databases. This data is often called “dormant data”. The retrieval of cold data typically takes longer than retrieval of data from a computer system's typical (or hot) storage location. The speed retrieval of cold storage varies and can take between minutes and hours. Thus, the analysis data management program 150 may be configured to detect low priority datasets having a criticality ranking (probability of usage) that is less than or equal to 20% (or any other suitable or desired preconfigured percentage). Using this example, if analysis data management program 150 detected an exemplary stored Dataset A and generated a criticality ranking of 10% for Dataset A, it would then automatically place the low priority Dataset A into cold storage, thus helping to address the challenge of storage space as more analysis data is generated and stored. In embodiments, analysis data management program 150 may be configured to purge stored datasets having a criticality ranking below a predetermined threshold.

It should be understood that analysis data management program 150 thus improves the ability to manage analysis data to conserve storage space both earlier in the data analysis workflow by limiting what datasets are ingested and analyzed and later in the data analysis workflow by ensuring that only datasets having a high probability of usage are stored. As discussed above, analysis data management program 150 is a machine learning model capable of continuously monitoring and learning. In the context of this disclosure, machine learning broadly describes a function of a system that learns from data. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule.

In embodiments, analysis data management program 150 may continuously monitor requests for analysis data that was previously deleted or moved to cold storage, and in response to detecting a request for analysis data that was previously deleted or moved to cold storage, automatically flag the corresponding requests and analysis data. This feature could ultimately be used to retrain analysis data management program 150 as needed.

It may be appreciated that FIG. 2 provides only an illustration of an exemplary implementation and does not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method, the method comprising:
automatically detecting a data analysis request made within a system and identifying one or more subject datasets;
automatically conducting shallow term assignments on each row and column of data in the subject datasets, the shallow term assignments comprising a domain classification;
automatically matching the shallow term assignments for each row and column with a stored set of ranked terms;
automatically flagging rows or columns matching with ranked terms in the stored set of ranked terms that are above a predetermined threshold ranking for performing further analysis;
automatically and continuously monitoring and detecting irrelevant metadata types within the flagged rows or columns by continuously utilizing historical usage data to prevent subsequent analysis and storage of data including the irrelevant metadata types;
in response to detecting a stored analysis dataset, automatically generating a criticality ranking for the stored analysis dataset, the criticality ranking comprising a numerical probability of usability for the stored analysis dataset; and
in response to detecting low priority analysis datasets having the criticality ranking below a criticality threshold, automatically placing the low priority analysis datasets into cold storage.

2. The computer-based method of claim 1, wherein, in response to detecting the low priority analysis datasets having the criticality ranking below the criticality threshold further comprises;
automatically purging the low priority datasets.

3. The computer-based method of claim 1, wherein the criticality ranking for the stored analysis datasets is generated by considering historical usage data, matches with the ranked terms, associated governance policies or rules, and past user interactions.

4. The computer-based method of claim 1, wherein automatically conducting the shallow term assignments on each row and column of data in the subject datasets further comprises:
automatically considering metadata and naming for each row and column.

5. The computer-based method of claim 1, wherein the stored set of ranked terms are domain-specific and manually marked and configured by one or more users.

6. The computer-based method of claim 1, wherein the stored set of ranked terms are automatically generated using one or more of usage data, a number of policies related to the term, a number of rules related to the term, a number of reports related to the term, and relationships of the term to one or more other high-ranking terms.

7. The computer-based method of claim 1 further comprising:
continuously monitoring requests for analysis data that was previously deleted or moved to the cold storage, and in response to detecting a request for analysis data that was previously deleted or moved to cold storage, automatically flagging the corresponding requests and analysis data.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
automatically detecting a data analysis request made within a system and identifying one or more subject datasets;
automatically conducting shallow term assignments on each row and column of data in the subject datasets, the shallow term assignments comprising a domain classification;
automatically matching the shallow term assignments for each row and column with a stored set of ranked terms;
automatically flagging rows or columns matching with ranked terms in the stored set of ranked terms that are above a predetermined threshold ranking for performing further analysis;
automatically and continuously monitoring and detecting irrelevant metadata types within the flagged rows or columns by continuously utilizing historical usage data to prevent subsequent analysis and storage of data including the irrelevant metadata types;
in response to detecting a stored analysis dataset, automatically generating a criticality ranking for the stored analysis dataset, the criticality ranking comprising a numerical probability of usability for the stored analysis dataset; and
in response to detecting low priority analysis datasets having the criticality ranking below a criticality threshold, automatically placing the low priority analysis datasets into cold storage.

9. The computer system of claim 8, wherein in response to detecting the low priority analysis datasets having the criticality ranking below the criticality threshold further comprises;
automatically purging the low priority datasets.

10. The computer system of claim 8, wherein the criticality ranking for the stored analysis datasets is generated by considering historical usage data, matches with the ranked terms, associated governance policies or rules, and past user interactions.

11. The computer system of claim 8, wherein automatically conducting the shallow term assignments on each row and column of data in the subject datasets further comprises:
automatically considering metadata and naming for each row and column.

12. The computer system of claim 8, wherein the stored set of ranked terms are domain-specific and manually marked and configured by one or more users.

13. The computer system of claim 8, wherein the stored set of ranked terms are automatically generated using one or more of usage data, a number of policies related to the term, a number of rules related to the term, a number of reports related to the term, and relationships of the term to one or more other high-ranking terms.

14. The computer system of claim 8, further comprising:
continuously monitoring requests for analysis data that was previously deleted or moved to the cold storage, and in response to detecting a request for analysis data that was previously deleted or moved to cold storage, automatically flagging the corresponding requests and analysis data.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
automatically detecting a data analysis request made within a system and identifying one or more subject datasets;
automatically conducting shallow term assignments on each row and column of data in the subject datasets, the shallow term assignments comprising a domain classification;
automatically matching the shallow term assignments for each row and column with a stored set of ranked terms;
automatically flagging rows or columns matching with ranked terms in the stored set of ranked terms that are above a predetermined threshold ranking for performing further analysis;
automatically and continuously monitoring and detecting irrelevant metadata types within the flagged rows or columns by continuously utilizing historical usage data to prevent subsequent analysis and storage of data including the irrelevant metadata types;
in response to detecting a stored analysis dataset, automatically generating a criticality ranking for the stored analysis dataset, the criticality ranking comprising a numerical probability of usability for the stored analysis dataset; and
in response to detecting low priority analysis datasets having the criticality ranking below a criticality threshold, automatically placing the low priority analysis datasets into cold storage.

16. The computer program product of claim 15, wherein in response to detecting the low priority analysis datasets having the criticality ranking below the criticality threshold further comprises;
automatically purging the low priority datasets.

17. The computer program product of claim 15, wherein the criticality ranking for the stored analysis datasets is generated by considering historical usage data, matches with the ranked terms, associated governance policies or rules, and past user interactions.

18. The computer program product of claim 15, wherein automatically conducting the shallow term assignments on each row and column of data in the subject datasets further comprises:
automatically considering metadata and naming for each row and column.

19. The computer program product of claim 15, wherein the stored set of ranked terms are domain-specific and manually marked and configured by one or more users.

20. The computer program product of claim 15, wherein the stored set of ranked terms are automatically generated using one or more of usage data, a number of policies related to the term, a number of rules related to the term, a number of reports related to the term, and relationships of the term to one or more other high-ranking terms.
